(19) United States
(12) Patent Application Publication
(10) Pub. No.: US 2025/0050677 A1
(43) Pub. Date: Feb. 13, 2025

(54) Book Assembly System

(71) Applicants: John Morrish, Newtown (GB); Edward Glen Morrish, Newtown (GB); Mark Peter Morrish, Newtown (GB)

(72) Inventors: John Morrish, Newtown (GB); Edward Glen Morrish, Newtown (GB); Mark Peter Morrish, Newtown (GB)

(21) Appl. No.: 18/798,681

(22) Filed: Aug. 8, 2024

(30) Foreign Application Priority Data
Aug. 9, 2023 (GB) 2312224.5

(51) Int. Cl. B42C 9/00; B42C 7/00

(52) U.S. Cl. CPC B42C 9/00; B42C 7/002

(57) ABSTRACT

A book assembly system comprising: a cover arrangement, having a support member for supporting a binder arrangement in an assembled configuration; a binder arrangement, having: a spine bar for carrying picture members, the spine bar having a spine portion interposing first and second holding portions, wherein the support member is arrangeable in the assembled configuration with: a corresponding side portion to adjoin the spine portion of the spine bar, and; corresponding first and second interconnecting portions to adjoin the respective first and second holding portions of the spine.

### TECHNICAL FIELD

The present disclosure relates to a book assembly, in which picture members are bound with a spine bar as a binder arrangement and a cover arrangement is connected there to.

### BACKGROUND

Picture members, e.g., photographic prints, can be bound with a spine bar as a binder arrangement. However, such arrangements are not cosmetically desirable since the binder arrangement does not present as a book. Moreover, the binder arrangement does not provide sufficient protection of the picture members.

Therefore, despite the effort already invested in the development of said binder arrangements, further improvements are desirable. In particular, it is desirable to provide a cost-effective customisable arrangement that is suitable for mass production.

### SUMMARY

The present disclosure provides, a book assembly system comprising: a cover arrangement, having a support member for supporting a binder arrangement in an assembled configuration, and; a binder arrangement, having: a spine bar for carrying picture members, the spine bar having a spine portion interposing first and second holding portions.

In embodiments, the support member is arrangeable in the assembled configuration with: a corresponding (e.g. in shape so it can be arranged contiguous) side portion to adjoin the spine portion of the spine bar, and; corresponding (e.g. in shape so it can be arranged contiguous) first and second interconnecting portions to adjoin the respective first and second holding portions of the spine bar.

By implementing the support member to extend around/contiguous the spine bar, it may reduce visibility of/conceal the spine bar, whilst giving an appearance of a hard back book supporting the picture members, but with the customisability/convenient assembly of the spine binder. As used herein the term “contiguous” may refer to being arranged in contact therewith and/or in close proximity, e.g., within a gap of 2 or 1 or 0.5 mm.

In embodiments, the portions of the support member are hingedly connected, e.g. with the first interconnecting portion hingedly connected at a first hinged connection to the back cover portion; the first interconnecting portion hingedly connected at a second hinged connection to the side portion; the second interconnecting portion hingedly connected at a third hinged connection to the side portion; the second interconnecting portion hingedly connected at a fourth hinged connection to the front cover portion.

By implementing the support member to have at least five flexible portions, it may extend contiguous the spine bar, including regardless of a number of picture members that are being supported by the spine bar, and may be flexible (e.g., by hinging of the front and or back cover portions) for convenient viewing of the individual picture carriers.

In embodiments, at least one of the hinged connections includes a channel portion (which can be blind or through hole) formed in the support member. By implementing a channel, a removed portion of the material may enable the hinge to form/hinge by collapsing of the channel, without unsightly bulging of the material. The channel may be formed on an interior face of the support member.

In embodiments, a profile of the channel portion includes a V-shaped base (e.g., two generally straight faces which come together at a vertex). By implementing a channel with a V-shaped base, an axis of the hinge may be precisely located by the apex of the V, e.g. so that adjoining sections of the support member are integral to each other.

In embodiments, a profile of the channel portion includes a U-shaped base (e.g., a generally curved face, with an apex/lowest potion at the middle). By implementing a channel with a U-shaped base, an axis of the hinge may be precisely located by the apex of the U, e.g. so that adjoining sections of the support member are integral/not integral to each other.

In embodiments, a profile of the channel portion includes a though hole, e.g. so that adjoining sections of the support member are not integral to each other.

In embodiments, the channel has a depth of 1-4 mm. For a though hole, a thickness of the material of the support member (e.g. 1-4 mm) forms the depth of the channel. For a V or other shaped channel the depth may be the maximum depth.

In embodiments, a width of the channel (e.g. at an opening of the channel, the width defined as the distance between adjoining sections of the support member) is at least twice the depth (i.e. the depth of the channel/material thickness). With such a dimension range, the channel may accommodate a thickness of the adjoining portions of the support member during hinging. A maximum width may be 4 or 6 times the depth.

In embodiments, the channel portions/hinge axis of the hinged connections extend parallel to each other.

In embodiments, the book assembly system comprises a bridging member, which is arranged to extend over an open end of the channel portion to close said channel portion. The bridging member may be flexible and define a collapsible cavity, which collapses (e.g., by flexing of the bridging member and/or displacement of the side walls of the channel) on hinging of the associated hinged connection. By implementing a bridging member (e.g., the cover sheet and/or a peripheral adhesive portion/flaps of a cover sheet coupling system/a carrier member) to cover at least part of the channel portion, the channel portion may be concealed, whilst it remains fully functional as a hinge. In embodiments, the bridging member is arranged over an interior face of the support member at a periphery thereof. In embodiments, the bridging member is arranged to prevent visibility of the channel (by bridging it) where the said channel (e.g. at the periphery) is not overlapped by the binder arrangement including an associated component (e.g. the first or second peripheral members of the coupling system that couple the binder arrangement to the cover arrangement) in the assembled configuration. The bridging member therefore conceals portions of the channel that are not concealed by the binder arrangement.

In embodiments, the cover arrangement includes a cover sheet coupling system for coupling, a cover sheet to the support member. By implementing a cover sheet coupling system to interconnect a cover sheet to the support member, e.g., to one or more of the: front cover portion; back cover portion; side portion; first holding portion, and; second holding portion, an adaptable outer may be provided to the book assembly system, which may be customised at an end user location. The coupling system may comprise an adhesive layer applied to the cover sheet and/or the support member/carrier member.

In embodiments, the book assembly system comprises a cover sheet. In embodiments, the cover sheet is adapted to wrap around any one or more of the front cover portion; back cover portion; side portion; first holding portion, and; second holding portion. By implementing the cover sheet to wrap around (e.g., so that interior and exterior faces and an edge are at least partially covered), including of all exposed peripheral edges of the support member, the book assembly system may conceal the support member. The side portion, first interconnecting portion and second interconnecting portions may also be wrapped around. Flaps of the cover sheet may be arranged over an interior face of the support member/carrier member

In embodiments, the cover arrangement comprises a carrier member that carries the support member. In embodiments, the carrier member is adapted to wrap around any one or more of the front cover portion; back cover portion; side portion; first holding portion, and; second holding portion. Flaps of the carrier member may be arranged over an interior face of the support member. The carrier member may be arranged between the cover sheet and support member. In embodiments, a shape of the carrier member may correspond to the cover sheet, e.g. so that said flaps overlap each other. The carrier member may couple to the support member by an adhesive portion arranged on the support member or the carrier member. The carrier member may couple to the support sheet by an adhesive portion arranged on the carrier member or the cover sheet (e.g. the carrier member may implement a double-sided adhesive layer).

In embodiments, the cover sheet coupling system comprises a fixing system for fixing the cover sheet to the support member (e.g. via the carrier member/the coupling system comprising the carrier member). The fixing system may comprise a peripheral adhesive portion (e.g., an adhesive strip) that extends over an interior face of the support member (e.g., one or more of the: front cover portion; back cover portion; side portion; first holding portion, and; second holding portion, over may refer to the adhesive portion arranged on the support member or over the carrier member that is arranged over the support member) for attachment of the cover sheet around an exterior face of the support member. The peripheral adhesive portion may only be arranged at the periphery of the interior face, e.g., not distal the centre.

In embodiments, the cover sheet coupling system comprises a face adhesive portion that extends over the exterior face of the support member (e.g., one or more of the: front cover portion; back cover portion; side portion; first holding portion, and; second holding portion or over the carrier member that is arranged over the support member) for attachment of the cover sheet to the exterior face support member.

In embodiments, the book assembly system comprises a coupling system for coupling, in the assembled configuration, the cover arrangement to the binder arrangement. In embodiments, the coupling system comprises at least one peripheral member of the binder system arranged to couple to an interior face of the support member. By connecting a peripheral member of the binder system to an interior face of the support member, a convenient and discrete coupling may be provided. The coupling system may be implemented at an end user location (e.g., at a location different to manufacturing of the associated components), after the end user has customised/selected the picture members for binding.

In embodiments, an exterior face of the peripheral member of the binder system is arranged to couple to said interior face via a fixing arrangement, which may comprise an adhesive connection, e.g., an adhesive strip.

In embodiments, at least one holding portion of the spine bar comprises a fixing arrangement for fixing the peripheral member to the spine bar. By connecting an interior face of a peripheral member to an exterior face of the holding portion, the peripheral member may conveniently/securely interconnect the binder arrangement and cover arrangement, including proximal the holding portion of the spine bar, which may provide a discrete connection between said components.

In embodiments, the fixing arrangement comprises: a guide portion to align an edge of the peripheral member to the spine bar, and; a securing arrangement to secure the aligned peripheral member (e.g., at an interior face thereof) to the spine bar. The securing arrangement may comprise an adhesive connection (e.g., an adhesive strip). By implementing a guide portion, the peripheral member may be accurately positioned in an aligned position before being fixed in said aligned position with the securing arrangement.

In embodiments, the book assembly system comprises picture members for carrying by the spine bar.

In embodiments, the book assembly system is arranged in the assembled configuration, e.g., to provide the book assembly, in which the cover arrangement supports the binder arrangement. In embodiments, the book assembly system is arranged in a disassembled configuration, e.g., with one or more components not in the assembled configuration, including the cover arrangement not supporting the binder arrangement.

### [Cover Arrangement]

The present disclosure provides a cover arrangement for a book assembly, the cover arrangement comprising a support member for supporting a binder arrangement in an assembled configuration. The cover arrangement may be implemented according to any preceding embodiment, or another embodiment disclosed herein.

### [Use]

The present disclosure provides use of the cover arrangement of any preceding embodiment, or another embodiment disclosed herein for supporting a binder arrangement of any preceding embodiment, or another embodiment disclosed herein.

The present disclosure provides use of a binder arrangement and/or a spine bar of any preceding embodiment, or another embodiment disclosed herein for supporting by a cover arrangement of any preceding embodiment, or another embodiment disclosed herein.

### [Method]

The present disclosure provides a method of assembling a book assembly. The book assembly may implement the cover arrangement of any preceding embodiment, or another embodiment disclosed herein and the binder arrangement of any preceding embodiment, or another embodiment disclosed herein.

In embodiments, the method comprises: arranging a support member of a cover arrangement to support a binder arrangement.

The method comprising arranging the support member to support the binder arrangement with: a corresponding side portion to adjoin the spine portion of the spine bar, and; corresponding first and second interconnecting portions to adjoin the respective first and second holding portions of the spine bar.

In embodiments, the portions of the support member are hingedly connected, e.g. with the first interconnecting portion hingedly connected at a first hinged connection to the back cover portion; the first interconnecting portion hingedly connected at a second hinged connection to the side portion; the second interconnecting portion hingedly connected at a third hinged connection to the side portion; the second interconnecting portion hingedly connected at a fourth hinged connection to the front cover portion.

In embodiments, the method comprises hinging at least one of the hinged connections with a channel portion comprising a V-shaped base.

In embodiments, the method comprises hinging at least one of the hinged connections around the binder arrangement.

The present disclosure provides the book assembly system of any preceding embodiment, or another embodiment disclosed herein and instructions (e.g., in written form) for assembly according to the method of any preceding embodiment or another embodiment disclosed herein.

### [Method of Forming]

The present disclosure provides a method of forming a cover arrangement for a book assembly. The book assembly may implement the cover arrangement of any preceding embodiment, or another embodiment disclosed herein.

In embodiments the method comprises: forming at least one channel portion into a support member of the cover arrangement to define a hinged connection between one or more of: a side portion; first and second interconnecting portions, and; front and back cover portions.

In embodiments, the method comprises forming the channel portion by cutting (e.g., by a cutting tool that removes a portion of material). In embodiments, the method comprises forming one or more of the channels of sequentially or concurrently.

In embodiments, the method comprises cutting at least one channel portion with one or more of: a V-shaped base; parallel sides; blind; straight through.

In embodiments, the support member is formed from a single piece, e.g., in which all channels are formed.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description, Figures, and Claims.

### BRIEF DESCRIPTION OF FIGURES

Aspects, features and advantages of embodiments of the present disclosure will become apparent from the following description of embodiments in reference to the appended drawings in which like numerals denote like elements.

FIG. 1 is a to scale side view showing an embodiment book assembly system arranged in an assembled configuration.

FIG. 2 is a plan view showing part of a cover arrangement of the book assembly system of FIG. 1 arranged in an unassembled configuration.

FIG. 3 is a perspective view showing part of the cover arrangement of the book assembly system of FIG. 1 arranged in an unassembled configuration.

FIG. 4 is a plan view showing a cover sheet of the cover arrangement of FIGS. 2 and 3.

FIGS. 5 and 6 are side cross-sectional views showing hinged connections of the cover arrangement of FIGS. 2 and 3.

FIGS. 7 and 8 are perspective views showing a binder arrangement of the book assembly system of FIG. 1 arranged in an unassembled configuration.

### DETAILED DESCRIPTION OF EMBODIMENTS

Before describing several embodiments of the book assembly system, it is to be understood that the book assembly system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein the term “book assembly system” may refer to an arrangement comprising a cover arrangement and a binder arrangement. In an assembled configuration, the system may be arrangement with the cover arrangement arranged as a cover for the binder arrangement, e.g., to obscure the binder arrangement and the picture members other than when viewed from a side. In a disassembled configuration the cover arrangement and binder arrangement may be as separate parts.

As used herein the term “cover arrangement” may refer to an arrangement that is capable of providing a front and/or back cover to the binder arrangement. The cover arrangement may extend around the binder arrangement and may cover over all surfaces other than the ends. The cover arrangement may include a support member and a carrier member that carries the support member. The cover arrangement may include a cover portion to cover the carrier member. As used herein the term “support member” may refer to a member capable of providing said covering function. The support member may be formed of sheet material. The support member may comprise a side portion and first and second interconnecting portions, which correspond in shape to a spine bar of the binder arrangement. The support member may comprise a paper based material (e.g., cardboard or paperboard) and/or a plastic based material or other material, e.g., a fibreboard. The support member may be formed by any suitable technique for forming a structure from the relevant material. For a plastic based material, it may be formed by one or more of: injection moulding; extrusion; machining from a solid material; stamping and/or cutting of a sheet; other forming process. For a paperboard or fibreboard material, it may be formed by stamping and/or cutting of a sheet. The support member may have a thickness of 0.5-5 mm or 1-3 mm.

As used herein the term “carrier member” may refer to an arrangement that is capable of carrying the portions of the support member relative each other in a range of operative positions. The carrier member may comprise a paper based and/or plastic based material or other material. The carrier member may comprise an adhesive liner, which may be double or single sided. The carrier member may have a thickness of 0.1-2 mm or 0.25-1 mm.

As used herein the term “cover portion” may refer to an arrangement that is capable of carrying the portions of the support member relative each other in a range of operative positions and/or provide a backing for the carrier member. The cover portion may comprise a paper based and/or plastic based material or other material. The cover portion may have a thickness of 0.1-3 mm or 0.25-2 mm.

As used herein the term “binder arrangement” may refer to an arrangement for binding picture members, and which may be covered by the cover arrangement. The binder arrangement may include a spine bar. As used herein the term “spine bar” may refer to an arrangement that provides a spine for one or more picture members arranged in a bound configuration. The spine includes a spine portion, which interposes first and second holding portions. An elasticity of said portions may provide a gripping force at opposed engagement portions of the first and second holding portions to implement said binding. The spine may be formed from a plastic and/or metal based material.

As used herein the term “picture member” may refer to a carrier, e.g., a planar backing substrate, to support a picture item, and may be arranged behind the picture item when supported. The picture member may be formed form sheet material. The picture item and the picture member may be integrally formed, e.g., the picture item is printed onto the picture member. The picture member can be formed of paper or cardboard. As used herein the term “picture” or “picture item” may refer to an item comprising a picture article that is suitable for display with a picture member, it can include: a photo; artwork that can include a painting; or other article. The picture item may comprise a picture face that presents the picture and a back face which is on an opposed face to the picture face. The picture member may be dimensions 5-50 cm by 5-50 cm, or 10-30 cm by 10-30 cm. The picture member may have a thickness of 0.1-2 mm.

As used herein the term “peripheral member(s)” may refer to an arrangement (e.g., both first and second peripheral members) that are capable of coupling the binder arrangement to the cover arrangement. The peripheral member may comprise a paper based and/or plastic based material or other material. The peripheral member may comprise single-sided adhesive liner, which may be double or single sided. The peripheral member may have a thickness of 0.1-2 mm or 0.25-1.5 mm.

As used herein the term “hingedly connected” may refer to a joint that is formed by flexing of material typically along a weakening potion in the material.

As used herein the term “sheet material” may refer to a material arrangement with a comparatively thin thickness and a large in-plane length and width. The sheet material may be supplied as individual sheets or as a continuous web. Examples include: paperboard; fibreboard; plastic; metal base foil; laminates of the aforesaid.

As used herein the term “paperboard” or “cardboard” may refer to a paper pulp-based board. A thickness of the material may be greater than 0.30 mm and/or a grammage of a grammage above 250 g/m2, hence to distinguish the material from paper. Paperboard may be single-ply or multi-ply.

As used herein the term “fibreboard” may refer to a wood product that is made from wood fibres or a kraft-based paperboard. It may include a kraft-based paperboard or corrugated fibreboard.

### [General Components of Book Assembly System]

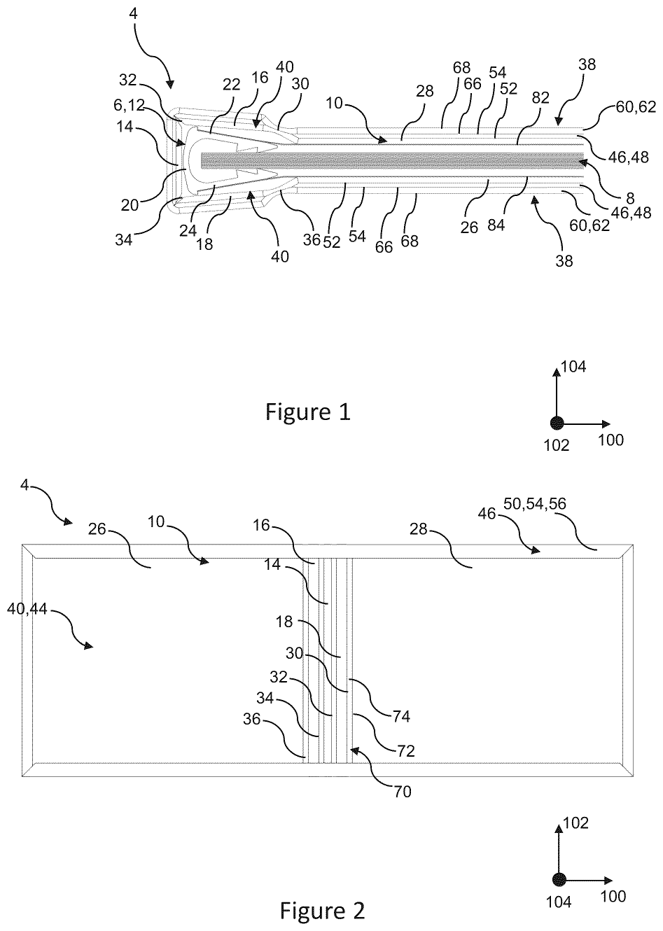

Referring to FIG. 1 a book assembly system 2 comprises a cover arrangement 4 and a binder arrangement 6. The binder arrangement 6 carries picture members 8.

Referring to FIGS. 1 and 2, the cover arrangement 4 includes a support member 10 for supporting the binder arrangement 6 in an assembled configuration (as shown in FIG. 1). The support member 10 includes a side portion 14, a first interconnecting portion 16, and a second interconnecting portion 18.

Referring to FIGS. 1, 6 and 7, the binder arrangement 6 includes a spine bar 12 for carrying the picture members 8 (as shown in FIG. 1). The spine bar 12 includes a spine portion 20 interposing a first holding portion 22 and a second holding portion 24.

In the assembled configuration of FIG. 1 the side portion 14 of the support member 10 adjoins the spine portion 20 of the spine bar 12, and first and second interconnecting portions 16, 18 of the support member 10 adjoin the respective first and second holding portions 22, 24 of the spine bar 12. In particular, the support member 10 extends contiguous to, and around, the spine bar 12, as will be discussed.

Referring to FIG. 2, in which the cover arrangement 4 is shown in a disassembled configuration. The cover arrangement 4 additionally includes a front cover portion 26 and a back cover portion 28.

In the illustrated example, the first interconnecting portion 16 is hingedly connected at a first hinged connection 30 to the back cover portion 28; the first interconnecting portion 16 is hingedly connected at a second hinged connection 32 to the side portion 14; the second interconnecting portion 18 is hingedly connected at a third hinged connection 34 to the side portion 14; the second interconnecting portion 18 is hingedly connected at a fourth hinged connection 36 to the front cover portion 26.

As best seen in FIG. 1, the support member 10 is implemented as five flexibly connected portions. This enables it to extend contiguous (e.g., in close proximity to and/or in contact therewith) the spine bar 12 and picture members 8 and to correspond to their form. This correspondence can be regardless of a total thickness of the picture members 8 that are carried by the spine bar 12, since the support member 10 can flexibly accommodate a range of thickness.

Moreover, the first hinged connection 30 and the fourth hinged connection 36 allow the book assembly system 2 to be opened, e.g., by hinging of said connections to hinge the front cover portion 26 and/or back cover portion 28 relative the spine bar 12, to view the picture members 8.

In variant embodiments, which are not illustrated, support member is implemented as other numbers of flexibly connected portions, for example, the first hinged connection and the fourth hinged connection are omitted so that there are only three flexibly connected portions.

The book assembly system extends with a longitudinal direction 106, e.g., from the spine to an edge opposed to the spine, a lateral direction 102, e.g., along the spine, and a depth direction 104, e.g. a through thickness direction in which the picture members 8 are stacked.

### [Cover Arrangement]

Referring to FIGS. 1-3, 5 and 6, the cover arrangement 4 includes exterior faces 38, which in the assembled configuration (FIG. 1) face outwards, and interior faces 40, which in said assembled configuration face inwards towards the picture members 8.

The cover arrangement 4 includes said support member 10, which is arranged as the side portion 14, the first interconnecting portion 16, the second interconnecting portion 18, the front cover portion 26, and the back cover portion 28. Said portions 14-28 are connected by said first—fourth hinged connections 30-36, as will be discussed. The portions individually include exterior faces 42, which in the assembled configuration (FIG. 1) face outwards, and interior faces 44, which in the assembled configuration face inwards towards the picture members 8.

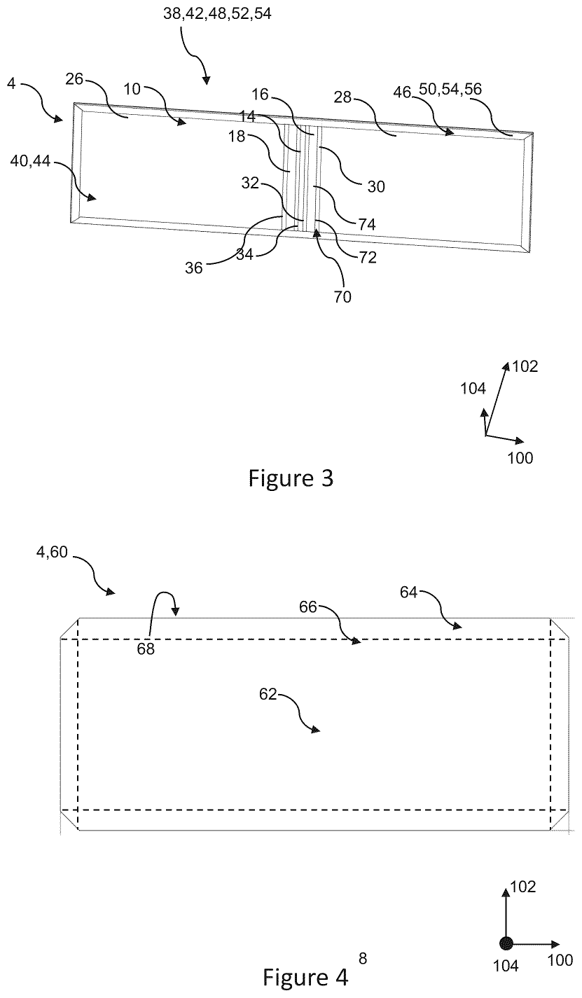

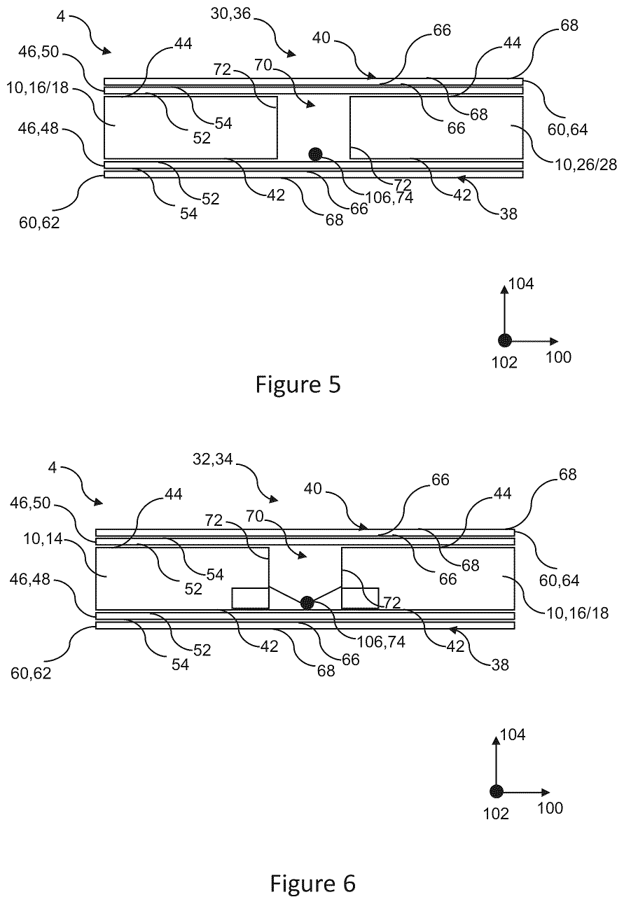

As best seen in FIGS. 2, 3, 5 and 6, the cover arrangement 4 includes a carrier member 46, which carries the support member 10. The carrier member 46 comprises a central portion 48 (which is the back hidden surface in FIG. 3 and the outer surface in FIG. 1) and flaps 50 (which is the front presenting surface on FIGS. 2, 3 and the inner surface on FIG. 1), which are arranged at periphery of the central portion 48. The carrier member 46 is arranged as sheet material. As best seen in FIGS. 5 and 6, a first surface 52 and a second surface 54 of the carrier member 46 comprise an adhesive layer, (e.g., the carrier member is a double-sided adhesive sheet), as will be discussed.

The first surface 52 of the central portion 48 of the carrier member 46 is adhered to the exterior faces 42 of the portions 14-28 of the support member 10.

As best seen in FIGS. 2, 5 and 6, the flaps 50 of the carrier member 46 are folded around the edges of the support member 10 and over the interior faces 44 of the portions 14-28 of the support member 10. The first surface 52 of the flaps 50 are adhered to the interior faces 44 of the portions 14-28 of the support member 10 at their peripheries. The flaps 50 (and peripheries to which the flaps 50 adhered) may have an orthogonal length of 1-5 cm or 1.5-5 cm from an edge/junction with the central portion 48. A backing sheet 56 (FIG. 2) is arranged over the adhesive layer of the second surface 54 of the carrier member 46, as will be discussed.

The adhesive layer of the second surface 54 of the flaps 50 thus forms a peripheral adhesive portion. The adhesive layer of the second surface 54 of the central portion 48 thus forms a face adhesive portion.

The carrier member 46 forms part of the hinged connections 30-36 and acts to maintain the portions 14-28 of the support members 10 in position, as will be discussed.

The carrier member 46 also implements a cover sheet coupling system for coupling a cover sheet 60 to the support member 10, as will be discussed.

In variant embodiment, which are not illustrated: the carrier member is omitted, e.g., the support member is configured to integrally connect its portions and may form the exterior surface of the cover arrangement; the carrier sheet only extends over some exterior faces of the support member, e.g., the back and/or front portion or at the hinges; the adhesive layer of the carrier sheet only extends over the flaps (e.g., so that only the peripheries of the cover sheet are adhered) or only extends over the central portion (e.g., so that only the central portion of the cover sheet is adhered).

### [Cover Sheet and Cover Sheet Coupling System]

Referring to FIGS. 1, 4, 5 and 6, the cover arrangement 4 includes a cover sheet 60, which is for fitting a decorative surface over the second surface 54 of the carrier member 46 and which (when fitted) forms the exterior faces 38 and interior faces 40 of the cover arrangement 4.

As best seen in FIG. 4, the cover sheet 60 comprises a central portion 62 and flaps 64, which are arranged at periphery of the central portion 62. The cover sheet 60 is arranged as sheet material. As best seen in FIGS. 5 and 6, a first surface 66 of the cover sheet 60 (which is the front presenting surface in FIG. 4) is for connecting to the adhesive layer of the second surface 54 of the carrier member 46. A second surface 68 of the cover sheet 60 (which is the hidden back surface in FIG. 4) is for carrying a picture item as defined herein.

More particularly, the first surface 66 of the central portion 62 of the cover sheet 60 is adhered to the adhesive layer of the of the second surface 54 of the central portion 48 of the carrier member 46. The flaps 64 of the cover sheet 60 are folded around the edges of the support member 10 and over the interior faces 44 of the portions 14-28 of the support member 10 and adhered to the second surface 54 of the flaps 50 of the carrier member 46. The flaps 60 may have an orthogonal length of 1-5 cm or 0.5-5 cm from an edge/junction with the central portion 62.

A planform of the cover sheet 60 thus corresponds to that of the carrier member 46, as will be discussed.

The adhesive layer of the carrier sheet 46 therefore implements a fixing arrangement. In variant embodiments, which are not illustrated, other fixing arrangements may be implemented, e.g., a mechanical fastener including a rivet.

The cover sheet 60 further forms part of the hinged connections 30-36 and acts to maintain the portions 14-28 of the support members 10 in position, as will be discussed. The cover sheet 60 also acts to conceal the support member.

With the cover sheet 60 coupled to the carrier member 46 and the support members 10: the second surface 68 of the cover sheet 60 forms the exterior surface 38 of the cover arrangement 4, and; the second surface 68 of the cover sheet 60 and the interior surface 44 of the support members 10 form together the interior surface 40 of the cover arrangement 4,

In variant embodiment, which are not illustrated: the cover sheet is omitted, e.g., the support member or carrier member is configured to form an exterior surface of the cover arrangement; the cover sheet only extends over some exterior faces of the support member, e.g., the back and/or front portion; the cover sheet has an adhesive layer as the first surface and is connected directly to the support members, thus obviating the carrier member/combining the coversheet with the carrier member.

### [Hinged Connection]

Referring to FIGS. 1, 5, and 6: a first hinge configuration (FIG. 5) is implemented by the first hinged connection 30 and the fourth hinged connection 36, and; a second hinge configuration (FIG. 6) implemented by the second hinged connection 32 and the third hinged connection 34. The hinge axis 106 of the hinged connections all extend parallel to each other.

In the examples below, the hinge configurations are illustrated at peripheries of the cover arrangement 4, hence said configurations include the overlapping flap 50 of the carrier member 46 and the overlapping flap 64 of the cover portion 46. Distal said peripheries, said overlapping portions may not be present. Hence said overlapping portions (which are referred to as bridging members) act at the peripheries to constrain and conceal the hinged connections, as will be discussed.

### [First Hinged Configuration]

Referring to FIG. 5, the first hinge configuration comprises: a channel portion 70 formed in the associated portions of the support member 10. The channel portion 70 is formed as a through hole, such that: the second interconnecting portion 18 is physically separated from the front cover portion 26, and; the first interconnecting portion 16 is physically separated from the back cover portion 28. The channel portion 70 may be formed by a cutting tool, or without cutting, e.g., by forming said portions from different sheet material. The channel 70 has parallel side walls 72, which extend in the lateral direction 102 and in the depth direction 104.

In variant embodiments, other channel forms may be implemented e.g., alternatively inclined and/or curved sidewalls.

The flaps 64 of the cover sheet 60 and the flaps 50 of the carrier member 46 extend over the periphery of the interior face 44 of the associated portions of the support member 10 to close the interior facing side of the channel 70.

The central portion 62 of the cover sheet 60 and the central portion 48 of the carrier member 46 extend over the periphery of the exterior face 42 of the associated portions of the support member 10 to close the exterior facing side of the channel 70.

Hence the cover sheet 60 and carrier member 48 act as a bridging member to bridge the channel 70. Since the cover sheet 60 and carrier member 48 are comparatively flexible compared to the support member 10, they define a collapsible cavity, which collapses on hinging of the associated hinged connection. Such an arrangement aids in concealing the hinged connection, which is aesthetically desirable.

By forming the channel 70 as a through hole, the first hinged connection 30 and the fourth hinged connection 36 can both hinge about the hinge axis 106 and also enable translation of the associated portions of the support member 10 in the longitudinal direction 102. This functionality may improve profiling of the book assembly system 2 and readability of the picture member 8.

### [Second Hinged Configuration]

Referring to FIG. 6, the second hinge configuration comprises: channel portion 70 formed in the associated portions of the support member 10. The channel portion 70 is formed as a blind hole, such that: the first interconnecting portion 16 is connected to side portion 14, and; the second interconnecting portion 18 is connected to the side portion 14, both by means of a living hinge.

The channel portion 70 may be formed by a cutting tool, e.g. a rotary tool including a router, or without cutting, e.g., by scoring to remove the section of the channel 70. The channel 70 has parallel side walls 72, which extend in the lateral direction 102 and in the depth direction 104, and a V-shaped base 74. The apex of the V-shape precisely locates the hinge axis 106. The channel 70 is formed in the interior face 44 of the associated portions of the support member 10, such that the exterior face 42 of the associated portions of the support member 10 (together with the bridging member formed by the carrier member 46 and the cover portion 60) form a living hinge/the base 74 of the channel.

In variant embodiments, other channel forms may be implemented: e.g., a U or otherwise curved and/or straight shaped base; a channel with alternatively inclined and/or curved sidewalls.

The flaps 64 of the cover sheet 60 and the flaps 50 of the carrier member 46 extend over the periphery of the interior face 44 of the associated portions of the support member 10 to close the mouth of the channel 70.

The central portion 62 of the cover sheet 60 and the central portion 48 of the carrier member 46 extend over the exterior face 42 of the associated portions of the support member 10 (and base 72 of the channel 70).

Hence the cover sheet 60 and carrier member 48 act as said bridging member to bridge the channel 70. Since the cover sheet 60 and carrier member 48 are comparatively flexible compared to the support member 10, at the bridging member they define a collapsible cavity, which collapses on hinging of the associated hinged connection. Such an arrangement aids in concealing the hinged connection, which is aesthetically desirable.

By forming the channel 70 as a blind hole, the second hinged connection 32 and the third hinged connection 34 can both hinge about the hinge axis 106, which is rigidly confined to the base of the channel 74. This functionality may improve profiling of the book assembly system 2 and precision in locating the portions support member 10 relative each other.

In variant embodiments, which are not illustrated, other hinged connection configurations may be implemented: including any of the first to fourth hinged connections can have the first or second or other hinged configuration, e.g. as formed by an axle and slot.

### [Spine Bar]

Referring to FIGS. 1, 7 and 8, the spine bar 12 comprises the spine portion 20, the first holding portion 22 and the second holding portion 24, which define a cavity 90 for receiving the picture members 8.

The first holding portion 22 and the second holding portion 24 have an interior surface 92 and an exterior surface 94, which face into and way from the picture members 8 (when received in the cavity 90 as shown in FIG. 1) respectively.

The interior surfaces 92 of both the first holding portion 22 and the second holding portion 24 have engagement portions 96 (e.g. teeth) at a tip thereof, which is distal the spine portion 20. The engagement portions 96 provide an opposed force in compression into the picture carrier members 8, which in combination with friction retaining them within the cavity 90.

The spine bar 12 is formed of a plastic-based material. In variant embodiments, other materials maybe implemented including a metal-based material. The material and geometry of the spine bar 12 is selected so that the engagement portions 96 are displaceable in the direction of the applied compressive force to accommodate a range of picture members 8 (that can vary in terms of individual quantity and/or thickness to have a range of different total thickness).

### [Coupling System]

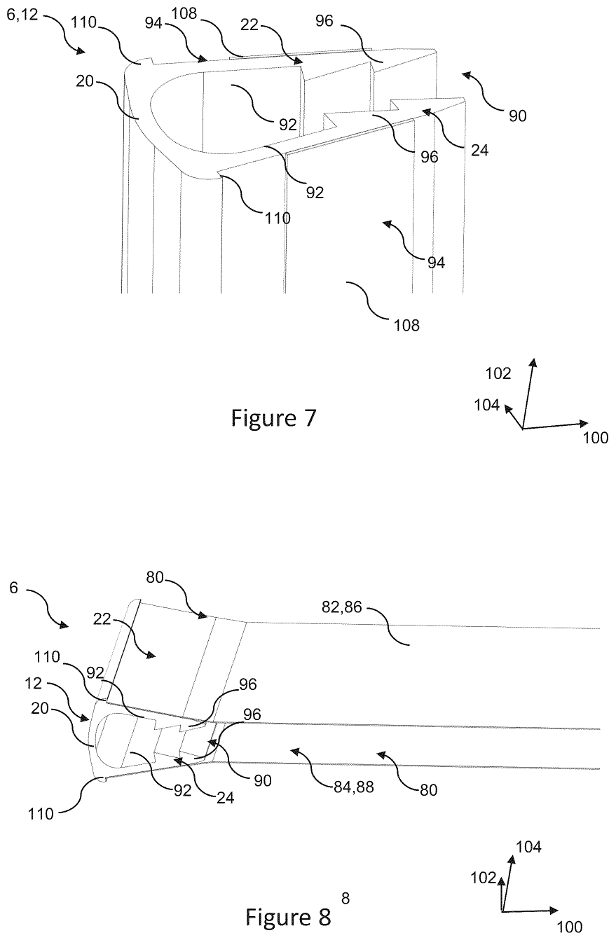

Referring to FIGS. 7 and 8, the book assembly system 2/binder arrangement 6 comprises a coupling system 80 for coupling, in the assembled configuration (as shown in FIG. 1), the cover arrangement 4 to the binder arrangement 6.

Referring to FIG. 8 in particular, the coupling system 80 comprises a first peripheral member 82 and second peripheral member 84 of the binder system 6. The first peripheral member 82 and second peripheral member 84 each comprise an exterior face 86 and an interior face 88, which face away from and into the picture members 8 respectively in the assembled configuration (as shown in FIG. 1).

The exterior face 86 of the first peripheral member 82 and second peripheral member 84 both comprise an adhesive layer. A backing sheet (not illustrated) may be arranged over said adhesive layer prior to coupling of the cover arrangement 4 to the binder arrangement 6, as will be discussed.

The exterior face 86 of the first peripheral member 82 and second peripheral member 84 in the assembled configuration both couple to the interior face 40 of the cover arrangement 4 (as best seen in FIG. 2). In particular, they couple to the interior faces 44 of the: first interconnecting portion 16; second interconnecting portion 18; front cover portion 26, and; back cover portion 28, of the support member 10 (as best seen in FIG. 2) as well as the second surface 68 of the flaps 64 of the cover portion 60 (as best seen in FIGS. 4, 5 and 6) that are interposed therebetween at the peripheries of the of the support member 10.

The exterior face 86 of the first peripheral member 82 and second peripheral member 84 coupled to overlap the flaps 64 of the cover portion 60 (but not fully, just sufficient to obscure a peripheral edge of the flaps 64) to ensure that the support member 10 can be fully concealed.

The adhesive layer of the peripheral members 82, 84 therefore implements a first fixing arrangement. In variant embodiments, which are not illustrated, other fixing arrangements may be implemented, e.g., a mechanical fastener including a rivet.

As best seen in FIGS. 7 and 8, the coupling system 80 further comprises on the spine bar 12: an adhesive portion 108 arranged on the exterior surfaces 94 of the first holding member 22 and the second holding member 24, and; a guide portion 110 arranged as a lip the exterior surfaces 94 of the first holding member 22 and the second holding member 24.

The guide portion 110 is arranged proximal the spine portion 20. The adhesive portion 108 interposes the guide portion 110 and the tips of the first holding member 22 and the second holding member 24 and is separated therefrom.

In use, as best seen in FIG. 8, a laterally extending edge of the first peripheral member 82 and the second peripheral member 84, which is proximal most the spine bar 12, is arranged to abut the guide portion 110 so that it is aligned therewith. The guide portion 110 protrudes as said lip so that said alignment can occur prior to bonding of the interior faces 88 of the first peripheral member 82 and the second peripheral member 84 to the adhesive portion 108. Hence once aligned the first peripheral member 82 and the second peripheral member 84 are rotated about the guide portion 108 to contact the adhesive portion 110 whilst maintaining said alignment.

The adhesive portion 90 and guide portion 92 therefore implement a second fixing arrangement.

In variant embodiments, which are not illustrated, other fixing arrangements may be implemented, e.g., a mechanical fastener including a rivet or staple; the guide portion of the spine bar may be omitted; the coupling system is alternatively configured e.g., as an adhesive layer that directly connects the spine bar to the cover arrangement; only one of the peripheral members is implemented. In the example of a staple based fixing arrangement, the staple may extend through the first or second peripheral member to the exterior surface of the associated first holding member or the second holding member, through the thickness of the holding member and optionally into the picture members to secure them in the spine.

### [Picture Members]

Referring to FIG. 1, the picture members 8 include on a front and/or back face the picture item. The picture item can be printed on said face(s) or adhered there to. Any number of picture members 8 can be implemented in the book assembly system 2, depending on their thickness and the dimensional configuration of the spine bar 12.

### [Method of Assembly]

A method of assembling the book assembly system 2 comprises the following steps:

The assembly process may be initiated with the cover arrangement 4 part pre-formed in the configuration of FIGS. 2 and 3.

Step 1: Referring to FIGS. 2-4, initially the cover sheet 60 (FIG. 4) is connected to the assembly of the support member 10 and the carrier member 46 (shown in FIGS. 2 and 3) of the cover arrangement 4.

Referring to FIGS. 2, 3, 4, 5 and 6, initially the backing sheet 56 (shown in FIGS. 2 and 3) is removed from the second surface 54 of the flaps 50 of the carrier member 46 to expose the adhesive layer on said flaps 50. The assembly of support member 10 and the carrier member 46 is subsequently placed face down on a support surface in abutment with a non-stick member to prevent adhesion of said adhesive layer on said flaps 50 to the support surface.

The cover sheet 60 of FIG. 4 is subsequently placed and on top of the backing sheet 56 over the second face 54 of central portions 48 the carrier member 46 (as best seen if FIG. 5) in alignment with the peripheries of the backing sheet 56 (that were removed from the flaps 50, and which acts as a guide to position the cover sheet 60).

Whilst maintained in said alignment, the cover sheet 60 is folded back on itself (e.g., so that the second surface 68 thereof contacts itself) and to expose a portion of the backing sheet 56. The exposed portion of the backing sheet 56 is subsequently folded back on itself to define a tab and at the same time define an adjoining exposed adhesive layer portion of the second surface 54 of the carrier member 46. The backing sheet 56 is maintained in said folded position so that as the cover sheet 60 is restored to its unfolded position it contacts, at its first surface 66, said expose an adhesive layer portion. The backing sheet 56 is then progressively removed by pulling the tab and the cover portion 60 is progressively adhered to the adhesively layer (either at the same time as removal of the backing sheet 56 or after full removal of the backing sheet 56).

In variant embodiments, the tab/exposed adhesive portion can be formed elsewhere on the adhesive layer.

The non-stick member is removed from the adhesive layer of the flaps 50 of the carrier member 46, and the second surface 68 of the central portion 62 of the cover portion 60 is subsequently placed face down on the support surface. The corners of the cover sheet 60 can be removed, e.g., by cutting (as illustrated in FIG. 4), such that the vertices of the assembly of the carrier member 46 and support member 10 intersects the cut lines.

The flaps 64 of the cover sheet 60 are subsequently folded around the assembly of the carrier member 46, and the support member 10 such that the first surface 66 of the flaps 64 of the cover sheet 60 engage the adhesive layer of the second surface 54 of the flaps 50 of the carrier member 46 (as shown in FIGS. 5 and 6). This step maybe conveniently executed by rotating the assembly of the carrier member 46, and the support member 10 with the flaps 64 against the support surface along its peripheral edges to manipulate the position of said flaps 64.

In variant embodiments, this step may be obviated, e.g.: the cover sheet and assembly of the carrier member and support member are pre-formed, or; the carrier member incorporates the picture item of the cover sheet. Alternative implementations of this step include: only adhering the flaps of the cover portion to the flaps of the carrier member and not the central portions (or the converse).

Step 2: Referring to FIG. 7, the picture members 8 (as shown in FIG. 1) are selected and inserted into the cavity 90 of the spine bar 12.

In variant embodiments, this step may be obviated, e.g.: the picture members are pre-inserted in the cavity of the spine bar.

Step 3: Referring to FIGS. 1, 5, 6 and 8, the cover arrangement 4 of Step 1 and the binder arrangement 6 of Step 2 are coupled using the coupling system 80.

Initially, referring to FIGS. 7 and 8, the first and second peripheral members 82, 84 are coupled to the binder arrangement 6. This comprises aligning the lateral direction 102 extending edge of the first peripheral member 82 that is proximal most the spine portion 20 of the spine bar 12, with the alignment portion 110 and initially without engagement of the adhesive portion 108 with the first peripheral members 82. Subsequently, with said edge maintained in alignment, the first peripheral members 82 is rotated about the alignment portion 110 until the adhesive portion 108 engages with the interior face 88 of first peripheral members 82, to achieved the coupled configuration shown in FIG. 8.

The process is then repeated for the second peripheral member 84 (or said second member may be coupled before the first member etc).

In variant embodiments, which are not illustrated, the first and second peripheral members are alternatively coupled to the spine bar, e.g., with mechanical fixings and/or without the alignment portion.

Subsequently (and initially with the adhesive backing sheet still attached to the exterior face 86 of the first and second peripheral members 82, 84) the cover arrangement 4 is hinged at the hinged connections 30-36 around the binder arrangement 6 to the position shown in FIG. 1. In this configuration the binder arrangement 6 is correctly aligned with respect to the cover arrangement 4.

Subsequently, to initially connect the first peripheral member 82 to the first interconnecting portion 16 and the back cover portion 28 of the cover arrangement 4: the second interconnecting portion 18, front cover portion 26 and side portion 14 are hinged about the associated hinged connections 32-36 relative the second peripheral member 84, to separate said items.

With the binder arrangement 6 maintained as aligned with respect to the cover arrangement 4, (e.g., with the first peripheral member 82, the first interconnecting portion 16 and the back cover portion 28 aligned to each other), the first peripheral member 82 (and picture members 8) are folded back to expose the backing sheet attached to the exterior face 86 of the first peripheral member 82.

In the same manner as described for Step 1: proximal the lateral direction 102 extending peripheral edge of the back cover portion 28, the first peripheral member 82 is folded back on itself and the backing sheet thereof is folded back on itself to expose an adhesive portion of the exterior face 86 of the first peripheral member 82 and define a tab; said first peripheral member 82 is subsequently folded back to its unfolded position and the exposed adhesive portion is subsequently adhered to the interior face 40 of the cover arrangement 4 (e.g., the interior face 44 of the back cover portion 28 and the second surface 68 of the cover portion 60); the tab formed by the backing sheet is then pulled to progressively in the longitudinal direction 100 to fully extract the backing sheet and adhere the adhesive layer of the first peripheral member 82 to the remainder of the back portion 28 and the first interconnecting portion 16 (at the cover portion 60 at their peripheries).

In variant embodiments, the tab/exposed adhesive portion can be formed elsewhere on the adhesive layer.

Subsequently, the backing sheet of the adhesive layer of exterior face 88 the second peripheral member 84 is removed and the adhesive layer thereof is adhered to the front portion 16 and the first interconnecting portion 16 (at the cover portion 60 at their peripheries).

In variant embodiments: the second peripheral portion is adhered first; other coupling processes are implemented, e.g., the adhesive layers of both the first and second peripheral members are be removed, and the binder arrangement inserted in the cover arrangement.

Variants of the above method maybe implemented, e.g., to account for the aforedescribed variant embodiments in the description.

### [Method of Manufacture]

A method of manufacturing the component parts of the cover arrangement 4 of the book assembly system 2 comprises the following steps.

Cutting (e.g., with a rotary cutting tool, including a router), at least one channel portion 70 into the support member 10 of the cover arrangement 4 to define the hinged connections 30, 32, 34, 36 between one or more of: the side portion 14; the first and second interconnecting portions 16, 18, and; front and back cover portions 26, 28.

The method may comprise cutting at least one channel portion 70 as a through hole or blind. The method may comprise cutting the blind channel 70 with a V-shaped or U-shaped base or other shaped base.

The method may comprise forming the portions 14, 16, 18, 26 and 28 of the support members 10 all from a single piece or more than one separate sheets. Separate sheets can be placed together to obviate the need for cutting a through hole channel.

The method may comprise connecting the formed portions 14, 16, 18, 26 and 28 to the carrier member 46 (e.g., by an adhesive layer of the carrier member 46, or by applying an adhesive to either of both of the adjoining surfaces) with an appropriate formation for forming the hinged connections. The method may comprise folding the flaps 50 of the carrier member 46 around the peripheries of the support members 10.

Variants of the above method maybe implemented, e.g., to account for the aforedescribed variant embodiments in the description.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

REFERENCES

```
2 Book assembly system
4 Cover arrangement
  10 Support member
      14 Side portion
      16 First interconnecting portion
      18 Second interconnecting portion
      26 Front cover portion
      28 Back cover portion
      Hinged connection
        70 Channel
            72 Walls
            74 V-shaped base
      30 First hinged connection
      32 Second hinged connection
      34 Third hinged connection
      36 Fourth hinged connection
      42 Exterior face
      44 Interior face
    46 Carrier member
      48 Central portion
      50 Flaps
      52 First surface
      54 Second surface
        56 Backing sheet
    38 Exterior faces
    40 Interior faces
    60 Cover sheet
      62 Central portion
      64 Flaps (bridging portion/
      66 First surface
      68 Second surface
  6 Binder arrangement
      12 Spine bar
      20 Spine portion
      22 First holding portion
      24 Second holding portion
      90 Cavity
      92 Interior surface
        96 Engagement portion
      94 Exterior surface
        108 Adhesive portion
        110 Guide portion
8 Picture members
80 Coupling system
82 First peripheral member
      86 Exterior face
      88 Interior face
    84 Second peripheral member
86 Exterior face
      88 Interior face
```

1. A book assembly system comprising:
a cover arrangement, having a support member for supporting a binder arrangement in an assembled configuration;
a binder arrangement, having: a spine bar for carrying picture members, the spine bar having a spine portion interposing first and second holding portions,
wherein the support member is arrangeable in the assembled configuration with: a corresponding side portion to adjoin the spine portion of the spine bar, and;
corresponding first and second interconnecting portions to adjoin the respective first and second holding portions of the spine bar,
the first interconnecting portion is hingedly connected at a first hinged connection to a back cover portion;
the first interconnecting portion is hingedly connected at a second hinged connection to the side portion;
the second interconnecting portion is hingedly connected at a third hinged connection to the side portion;
the second interconnecting portion is hingedly connected at a fourth hinged connection to a front cover portion,
wherein at least one of the hinged connections includes a channel portion formed with the support member,
the system includes a bridging member, which is arranged to extend over an open end of the channel to close said channel, and define a collapsible cavity, which collapses on hinging of the hinged connection, and
the bridging member is arranged over an interior face of the support member at a periphery thereof, to prevent visibility of the channel where said channel is not overlapped by the binder arrangement in the assembled configuration.

2. The book assembly system of claim 1, wherein a profile of the channel portion includes a: V-shaped; or U-shaped base; or a though hole.

3. The book assembly system of claim 1, wherein the channel has a depth of 1.5 mm-4 mm and a width of at least twice the depth and a maximum width of 4 times the depth.

4. The book assembly system of claim 1, wherein the channel portions of the hinged connections extend parallel to each other.

5. The book assembly system of claim 1, wherein the cover arrangement includes a cover sheet coupling system for coupling, a cover sheet to the support member.

6. The book assembly system of claim 5, comprising a cover sheet, which is configured to wrap around the support member.

7. The book assembly system of claim 6, wherein the cover sheet coupling system comprises:
a peripheral adhesive portion that extends over an interior face of the support member for attachment of the cover sheet around an exterior face of the support member; and/or
a face adhesive portion that extends over the exterior face of the support member for attachment of the cover sheet to the exterior face of the support member.

8. The book assembly system of claim 6, wherein the cover arrangement comprises a carrier member that carries the support member, and the cover sheet and carrier member form the bridging member.

9. The book assembly system of claim 1 comprising a coupling system for coupling, in the assembled configuration, the cover arrangement to the binder arrangement.

10. The book assembly system of claim 9, wherein the coupling system comprises at least one peripheral member of the binder system arranged to couple to an interior face of the support member.

11. The book assembly system of claim 10, wherein an exterior face of the peripheral member of the binder system is arranged to couple to said interior face via a fixing arrangement, which comprises an adhesive connection.

12. The book assembly system of claim 10, wherein at least one holding portion of the spine bar comprise a fixing arrangement for fixing the peripheral member to the spine bar.

13. The book assembly system of claim 12, wherein the fixing arrangement comprises:
a guide portion to align an edge of the peripheral member to the spine bar, and;
a securing arrangement to secure the aligned peripheral member at an interior face thereof to the spine bar, wherein the securing arrangement comprises an adhesive connection.

14. The book assembly system of claim 1 comprising picture members for carrying by the spine bar, with the book assembly system arranged in the assembled configuration.

15. A cover arrangement for a book assembly, the cover arrangement comprising a support member for supporting a binder arrangement in an assembled configuration, the binder arrangement, having: a spine bar for carrying picture members, the spine bar having a spine portion interposing first and second holding portions,
wherein the support member is arrangeable in the assembled configuration with: a corresponding side portion to adjoin the spine portion of the spine bar, and; corresponding first and second interconnecting portions to adjoin the respective first and second holding portions of the spine bar,
the first interconnecting portion is hingedly connected at a first hinged connection to a back cover portion;
the first interconnecting portion is hingedly connected at a second hinged connection to the side portion;
the second interconnecting portion is hingedly connected at a third hinged connection to the side portion;
the second interconnecting portion is hingedly connected at a fourth hinged connection to a front cover portion,
wherein at least one of the hinged connections includes a channel portion formed in the support member,
the system includes a bridging member, which is arranged to extend over an open end of the channel to close said channel, and define a collapsible cavity, which collapses on hinging of the hinged connection.
and the bridging member is arranged over an interior face of the support member at a periphery thereof, to prevent visibility of the channel where said channel is not overlapped by the binder arrangement in the assembled configuration.

16-17. (canceled)

18. A method of assembling a book assembly, the method comprising:
arranging a support member of a cover arrangement to support a binder arrangement, with: a corresponding side portion to adjoin a spine portion of the spine bar, and; corresponding first and second interconnecting portions to adjoin respective first and second holding portions of the spine bar, with the second interconnecting portion connected to a front cover portion, and with the second interconnecting portion connected to a back cover portion wherein the portions of the support member are hingedly connected, and at least one of the hinged connections includes a channel portion formed in the support member,
arranging a bridging member, which is arranged to extend over an open end of the channel to close said channel, and define a collapsible cavity, which collapses on hinging of the hinged connection with the bridging member arranged over an interior face of the support member at a periphery thereof, to prevent visibility of the channel where said channel is not overlapped by the binder arrangement in the assembled configuration.

19. The method of claim 18 comprising hinging at least one of the hinged connections with a channel portion comprising a V-shaped base.

20. The method of claim 18 comprising hinging at least one of the hinged connections around the binder arrangement.

21. The book assembly system of claim 1, further comprising:
instructions for assembling the book assembly comprising the following steps:
arranging a support member of a cover arrangement to support a binder arrangement, with: a corresponding side portion to adjoin a spine portion of the spine bar, and; corresponding first and second interconnecting portions to adjoin respective first and second holding portions of the spine bar, with the second interconnecting portion connected to a front cover portion, and with the second interconnecting portion connected to a back cover portion wherein the portions of the support member are hingedly connected, and at least one of the hinged connections includes a channel portion formed in the support member,
arranging a bridging member, which is arranged to extend over an open end of the channel to close said channel, and define a collapsible cavity, which collapses on hinging of the hinged connection with the bridging member arranged over an interior face of the support member at a periphery thereof, to prevent visibility of the channel where said channel is not overlapped by the binder arrangement in the assembled configuration.

22-24. (canceled)
